(19) United States
(12) Patent Application Publication
(10) Pub. No.: US 2023/0289670 A1
(43) Pub. Date: Sep. 14, 2023

(54) SYSTEM INTEGRATION IN A DISTRIBUTED COMPUTING ENVIRONMENT

(71) Applicant: FIL Investment Management Limited, London (GB)

(72) Inventor: Ashley Knight, Redhill (GB)

(73) Assignee: FIL Investment Management Limited, London (GB)

(21) Appl. No.: 18/165,421

(22) Filed: Feb. 7, 2023

(30) Foreign Application Priority Data
Mar. 14, 2022 (GB) 2203520.8

(51) Int. Cl. G06Q 10/02

(52) U.S. Cl. CPC G06Q 10/02

(57) ABSTRACT

A computer system configured to effect integration of a booking system with a communication system is provided. A contact management component obtains, via a first interface, a set of contacts of the user within a communication system. A booking management component obtains a contact identifier from the set of contacts, locates, via a second interface, an existing work area booking associated with the identifier, and generates a booking suggestion for the user comprising an identifier of an available work area, available at a suggested booking time, and determined based on a timing and a location of the existing work area booking. A rendering component renders the booking suggestion in a user interface. The booking suggestion is selectable to cause a booking request to be submitted to the second interface, the booking request comprising an identifier of the user, the suggested booking time, and the identifier of the available work area.

### TECHNICAL FIELD

The present disclosure pertains generally to improved system integration in a distributed computing environment.

### BACKGROUND

The use of productivity applications and software, corresponding to service systems, are becoming widespread in the workplace. Such service systems include communications systems which allow users to communicate with each other via email or video calls for example, scheduling systems which maintain and manage user's schedules or calendars, and booking systems for booking desks or rooms in a building.

A user is able to access each of these systems via the corresponding application or software. If a user wishes to access functions of each of the services, a different application must be used for each service. This is both time-consuming for the user and requires the user to manage any interactions between the services themselves. Different productivity systems generally operate largely independently of each other, in a distributed computing architecture, with limited or sub-optimal integration (if any) between the different systems. Among other things, this can lead to duplicate information being stored and managed across different, independent systems, often in different formats or schemas, and a high degree of manual effort required (often by end users) to access and correlate information across different productivity services.

### SUMMARY

It would therefore be desirable to provide improved integration between different and (largely) independent productivity systems, application, services and the like deployed in a distributed computing environment. Improved integration may, for example, streamline user access to the functions provided by the services, this removing or reducing the onus on the user of the services. Another benefit is the improved management of information and data between independent productivity systems.

According to a first aspect herein, there is provided a computer system configured to effect integration of a booking system with a communication system, the booking system for managing bookable work areas within one or more workplaces, the communication system for effecting one or more communication modalities between users thereof, the computer system comprising: a rendering component configured to render a user interface on a display of a user device operated by a user; a contact management component configured to obtain, via a first interface of the communication system, a set of contacts of the user within the communication system; and a booking management component configured to obtain a contact identifier from the set of contacts, locate, via a second interface of the booking system, an existing work area booking associated with the contact identifier, and generate a booking suggestion for the user comprising an identifier of an available work area, wherein the available work area is available at a suggested booking time, the available work area determined based on a timing and a location of the existing work area booking; wherein the rendering component is configured to render the booking suggestion in the user interface, the booking suggestion selectable to cause a booking request to be submitted to the second interface, the booking request comprising an identifier of the user, the suggested booking time, and the identifier of the available work area.

The integration system set out above uses data collected from multiple different systems, specifically the communication system and the booking system, to provide the user with the most relevant booking options, such that the user does not need to separately access the systems and then determine for themselves the optimum booking location. The user is therefore provided with the most relevant information. The booking request is also streamlined, as the user need only select the suggested booking for the booking request to be instigated.

In some embodiments, the system may be further configured to integrate a scheduling system, the scheduling system for managing a schedule of each user thereof, wherein the system may further comprise a scheduling management component configured to obtain, via a third interface of the scheduling system, a first portion of a first schedule associated with the user and a second portion of a second schedule associated with the contact identifier, wherein the first portion and the second portion comprise an overlap portion in time.

In some embodiments, the scheduling management module may be further configured to determine, based on the first portion and the second portion, the suggested booking time.

In some embodiments, selecting the booking suggestion may further causes a scheduling request to be submitted to the third interface, the scheduling request comprising the identifier of the user, the contact identifier, and the suggested booking time.

In some embodiments, the rendering component may be configured to render at least one user selectable contact element in the user interface, each user selectable contact element corresponding to one of the set of contacts.

In some embodiments, the contact identifier may be obtained based on a user selection of one of the at least one user selectable contact elements.

In some embodiments, the set of contacts may be a set of preferred contacts, wherein the set of preferred contacts are generated based at least in part on relative frequency of communication between the user and the preferred contacts in the communication system.

In some embodiments, the set of contacts may be a set of preferred contacts, wherein the set of preferred contacts is based at least in part on a user selection of contacts, wherein the contact management component is configured to maintain the set of preferred contacts.

In some embodiments, the booking management component may be configured to receive the suggested booking time based on a user provided booking time.

In some embodiments, the booking management component may be configured to determine the suggested booking time based on the existing work area booking.

In some embodiments, the scheduling management component may be configured to determine the suggested booking time based on the first portion and second portion.

In some embodiments, the booking management component may be configured to generate a plurality of booking suggestions, wherein the plurality of booking suggestions are rendered in the user interface.

In some embodiments, the booking suggestion may be based on a set of defined work area requirements and a set of assigned work area attributes associated with the identifier of the available work area.

In some embodiments, the set of defined work area requirements may be defined based on a scheduled event scheduled in the overlap portion.

According to a second aspect herein, there is provided a computer implemented method for effecting integration of a booking system with a communication system, the booking system for managing bookable work areas within one or more workplaces, the communication system for effecting one or more communication modalities between users thereof, the method comprising: rendering, by a rendering component, a user interface on a display of a user device operated by a user; obtaining, by a contact management component, via a first interface of the communication system, a set of contacts of the user within the communication system; obtaining, by a booking management module, a contact identifier from the set of contacts, locating, via a second interface of the booking system, an existing work area booking associated with the contact identifier, and generating a booking suggestion for the user comprising and an identifier of an available work area, wherein the available work area is available at a suggested booking time, the available work area determined based on a timing and a location of the existing work area booking; and rendering, by the rendering component, the booking suggestion in the user interface, the booking suggestion selectable to cause a booking request to be submitted to the second interface, the booking request comprising an identifier of the user, the suggested booking time, and the identifier of the available work area.

According to a third aspect herein, there is provided a computer program product comprising code stored on a computer readable storage medium and configured to implement the method set out above.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic diagram of an example computer system for implementing an integration system;

FIG. 2 is a schematic diagram of the integration system comprising a set of modules processing information obtained from integrated systems;

FIG. 3 provides an example method for booking a bookable work area for a remote meeting and initiating the remote meeting;

FIG. 4 provides an example method for booking a workable area near a location of a user's contact;

FIG. 5 shows an example user dashboard interface;

FIGS. 6a-c show an example user interface for initiating the remote meeting in the nearby work area;

FIGS. 7a-d show an example user interface for booking the nearby work area for the remote meeting;

FIGS. 8a-g show an example user interface for booking a bookable work area;

FIGS. 9a-d show an example user interface for booking a bookable work area near to a contact's booked work area′

FIG. 10a-b shows an example user interface for scheduling a remote meeting with a contact;

FIG. 11 shows an example user interface for expanding a user's network; and

FIG. 12 shows an example user interface for providing occupancy data of buildings.

### DETAILED DESCRIPTION

A platform, referred to as “WorkPlace”, is provided which integrates a variety of services to provide an easy-to-use application for use in a working environment. The platform is intended for use in a working environment comprising at least one office building with a set of bookable work areas. The bookable work areas may be single desks or whole rooms, for example a meeting room.

Example services which can be integrated a communication system 120b such as a Microsoft Office suite, a desk booking system 120c such as Condeco, a scheduling system 120d such as Microsoft Office calendars, and a video conference/call system 120e such as Zoom. It will be appreciated that one or more of the service systems 120b-e may be combined. For example, the communication system 120b and scheduling system 120d may be comprised in a single service system 120.

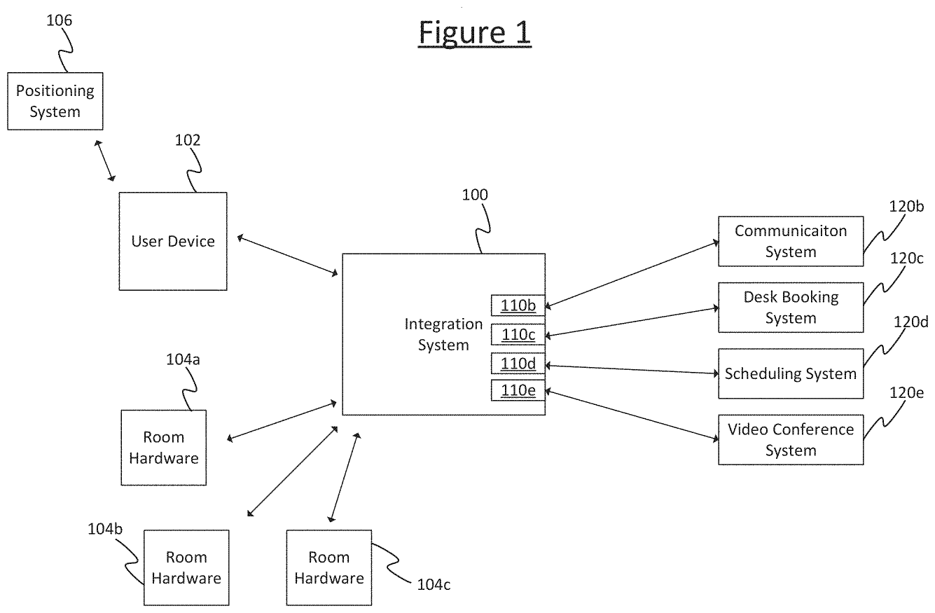

FIG. 1 shows an example computer system for implementing the platform, or integration system 100. The integration system 100 comprises application program interfaces (APIs) 110b-e for communicating with each of the service systems 120b-e respectively. APIs are a type of interface which provides a connection between computer programs and are known in the art.

The integration system 100 also communicates with a user device 102, such as a mobile phone or personal computer, and with room hardware 104a-c.

The user device 102 may store, in a memory, an application for accessing the integration system 100. Alternatively, the user device 102 may access the integration system 100 via a web browser. The user device 102 therefore provides an interface via which the user can interact with the integration system 100 and the service systems 120b-e. The integration system 100 may be implemented locally on the user device 102 or remotely to the user device 102 for example on a cloud computing device or a server or other computing device of the working environment.

The room hardware 104a-c comprises hardware devices for effecting a conference call, such as speakers, camera, and/or a computer device. The room hardware 104a-c may also comprise devices such as lighting, heating, and/or other environment controllers. Three sets of room hardware 104a-c are shown in the example of FIG. 1. Each set of room hardware 104a-c may correspond to a different room of the office building. In such an embodiment, the room hardware 104a-c may comprise a central room hardware module which communicates with each of the other elements of the room hardware and the integration system. Alternatively, the integration system 100 may communicate directly with each element of the room hardware 104a-c.

The integration system 100 communicates with each of the service systems 120, the user device 102, and the room hardware 104 via a wireless network, such as the Internet. The integration system 100, user device 102, and room hardware 104 may form a local area network (LAN).

The computer system further comprises a positioning system 106 which communicates with the user device 102. The positioning system 106 may be an indoor positioning system, which may comprise Bluetooth beacons positioned within a building which communicate directly with the user deceive 102, allowing the user device 102 to be located within the building via triangulation. Such indoor positioning systems are known in the art.

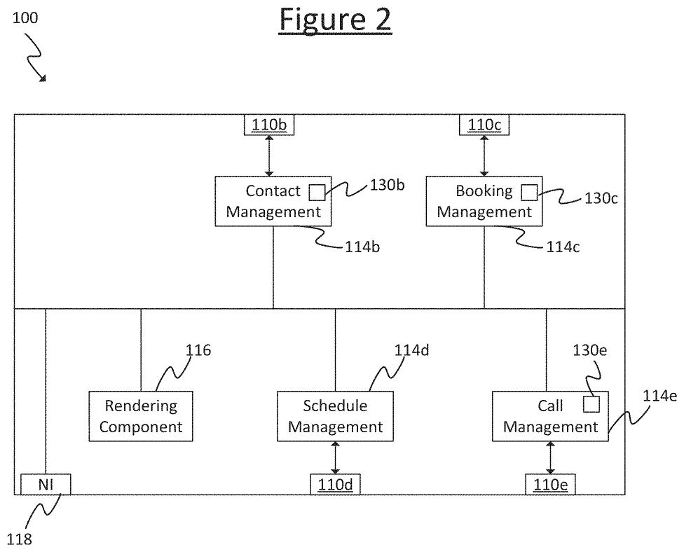

The integration system 100 comprises service management modules 114b-e, as shown in FIG. 2. Each service management module 114b-e corresponds to one of the service systems 120b-e with which the integration system 100 communicates, and communicates with its respective service system 120b-e via the corresponding API 110b-e, such that the service management modules 114b-e can obtain information from and store information to the corresponding service systems 120b-e.

The service management modules 114b-e are in communication with one or more of the other service management modules 114b-e. In the example of FIG. 2, each service management module 114b-e is able to communicate with each of the other service management modules 114b-e. The communication links between the service management modules 114b-e may depend on the function of each management modules 114b-e and the information required for the modules 114b-e to perform their functions.

The service management modules 114b-e of the integration system 100 comprise a contact management module 114b, a booking management module 114c, a schedule management module 114d, and a call management module 114e. The contact management module 114b, booking management module 114c, and call management modules 114e are each shown to comprise a database 130. These databases 130 may be used to store rules, user data, and/or data extracted from the associated service system 120 as required for the function of the management module 114. It will be appreciated that any of the management modules 114b-e may comprise a database 130, as required by their function.

The integration system 100 also comprises a rendering module 116, which is in communication with each of the service management modules 114b-e. The rendering module 116 is configured to render a user interface on a display of the user device 102. The user interface may comprise information extracted from the service systems 120b-e by the service management components 114b-e via their respective APIs 110b-e.

The integration system 100 communicates with the user device 102 and the room hardware 104 via a network interface 118. Data received from the user device 102 and/or room hardware 104 is passed from the network interface 118 to the relevant service management module 114b-e. The user interface, once rendered by the rendering module 116, is passed to the user device 102 via the network interface 118, and other data and/or instructions may be passed from one or more of the management modules 114b-e to the room hardware 104 via the network interface 118.

The integration system 100 may be used to integrate any combination of the service systems 120b-e with which it communicates. Some example use cases are provided below.

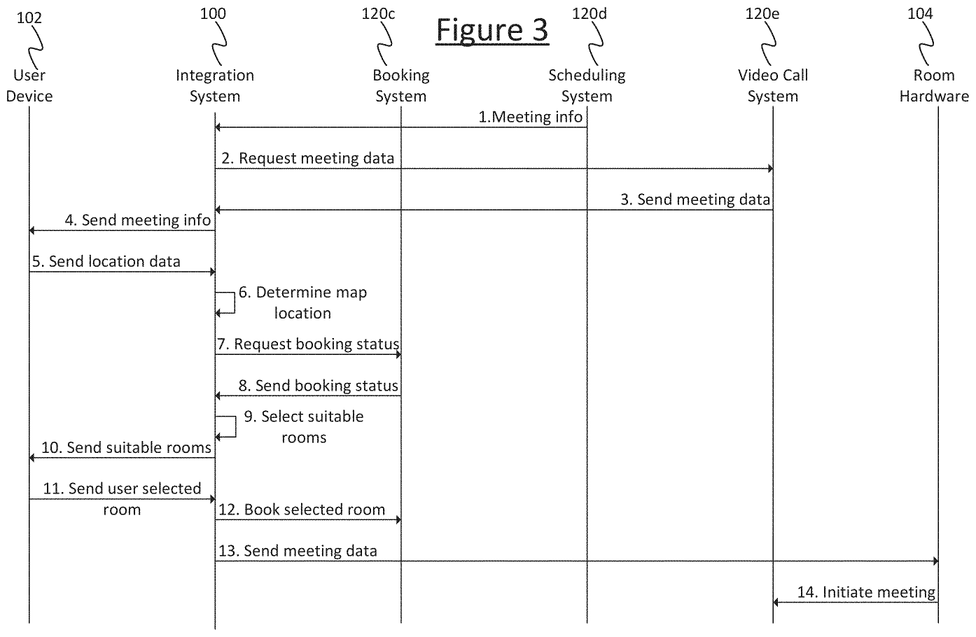

Location Based Booking FIG. 3 shows an example use case in which a current location of the user device 102 is used to book a work area for a video call. The integration system 100 uses data extracted from the booking system 120c, scheduling system 120d, and video call system 120e in the example of FIG. 3.

The scheduling system 120d stores scheduling data, such as a calendar, for each user of the scheduling system 120d. The scheduling API 110d pulls data corresponding to the user of the user device 120 from the scheduling system 120d. This data may be extracted by providing to the scheduling system 120d a user identifier associated with the user.

The schedule management module 114d receives the scheduling data and determines an upcoming scheduled meeting. For example, the schedule management module 114d may determine from the extracted scheduling data that the user has a meeting scheduled in 5 minutes time, and that the meeting is to take place using a particular video conference system 120e.

The integration system 100 requests meeting data corresponding to the identified meeting from the video call system 120e. In order to request this data, the schedule management module 114d passes the meeting identifier to the call management module 114e, which then requests the call data using the meeting identifier via the video conference API 110e.

The meeting data is provided to the call management module 114e via the video conference API 110e from the video call system 120e. The call management module 114e processes the meeting data, if required, such that it is machine readable. The meeting data may be stored in the database 130e of the call management module 114e for later use.

The rendering component 116 generates a user interface for providing the user with the meeting information. The meeting information provided to the user may comprise, for example, the start time and duration of the meeting, the attendees of the meeting, the meeting identifier, a title of the meeting, and/or documents associated with the meeting. The user interface is provided to the user device 102 for display.

The user device 102 sends its location data to the integration system 100. The location data may be sent in response to a request from the integration system 100 or in response to receiving meeting information. Alternatively, the location data may be sent in response to the user providing an input at the user device indicating that they wish to book a work area. The location data may comprise data collected using the positioning system 106. The location data may also comprise GPS data of the user device 102. The location data collected using the positioning system 106 may be based on indoor positioning signals received at the user device 102 from the positioning system 106 and to which a localisation process has been applied.

The location data is used by the integration system 100 to determine a current location of the user device 102 on a floor plan. The booking management module 114c stores, in its database 130c, floor plans for all buildings for which the integration system 100 can be used. Based on the received location data, the booking management module 114c identifies the relevant floor plan and the location of the user device 102 on the floor plan. If GPS data is provided, this may be used to determine a building in which the user device 102 is located in order to determine a relevant (set of) floor plans for the building. Alternatively, the location data derived from the positioning system 106 may indicate the building and thus be used to identify the relevant floor plans.

The booking management module 114c extracts, via the booking API 110c, booking statuses of bookable work areas near to the user, based on the determined user device 102 location on the floor plan. For example, the booking management module 114c may extract the booking statuses of all work areas within a 20 metre radius of the user device 102.

The booking management modules 114c may extract only booking statuses of the bookable work areas for the time of the scheduled event. Alternatively, the booking management modules 114c may extract booking statuses for a period of time encompassing the scheduled event, and including additional time. For example, the booking management modules 114c may extract booking statuses from a current time until a time 30 minutes after the scheduled end of the scheduled event.

The booking management module 114c selects from the received booking statuses one or more suitable rooms. The suitable rooms may be rooms within a predefined distance of the user device 102 and which have an unoccupied status at the time of the scheduled event. The suitable rooms may also be rooms which meet one or more requirements for the scheduled event. For example, in the case of the video conference event, the room is required to have a speaker, microphone, and screen. The room may also be required to have a predefined number of chairs as defined by a number of in-person attendees specified in the meeting information.

Room specifications, comprising information such as the equipment in the room and the capacity of the room, may be stored on the floor plan. Alternatively, the room specification may be stored in the booking management database 110c in association with a room identifier, with the room identifiers providing a link between the room specifications and the floor plan.

The requirements may be defined by a set of rules stored in the database 110c. The booking management module 114c accesses the rules and compares the rules to the room specifications to determine suitable rooms. The rules are defined in a back-end program which can be modified to alter, add, or remove rules for determining suitable rooms. Such rules may define, for example, hardware required in the room for a specific type of meeting and/or that the capacity of the room is at least equal to a number of in-person attendees of the meeting.

Once the suitable rooms have been determined, they are provided to the user device 102 for display. The information is first passed to the rendering component 116 to render the user interface for display.

The user is provided with information relating to the available rooms via the user device 102. For example, the user may be provided with a visual floor plan of the building in which the user device 102 is located, with an indication in or near each room of the booking status of the room for the duration of the scheduled event. The user may be able to select a room to see additional information about the room, for example the booking status of the room for the whole day may be provided to the user on the user device and/or the specification of the room.

The user selects, via the user interface, a room to book for the scheduled event. An identifier of the user selected room is provided to the booking management module 114c which amends the booking status of the room in the booking system 120c via the booking API 110c.

The integration system 100 provides the meeting data to the hardware 104 in the selection room. The booking management module 114c, having received the user selected room, requests the meeting data, stored in database 130e, from the call management module 114e. The booking management module 114c provides the meeting data to the room hardware 104 via the network interface 118.

The room hardware 104 initiates the call with the video conference system 120e using the received meeting data automatically when the meeting is scheduled to start.

In some embodiments, the room hardware 104 comprises hardware which is configured to communicate directly with video call system 120e via an AIP of the video call system 120e (not shown). The room hardware 104 is configured to pull data from the API of the video call system 120e.

In other embodiment, the room hardware 104 comprises hardware which is not able to communicate directly with the video call system 120e. In such an embodiment, an additional tool is required to replicate the communication between the room hardware 104 and the video call system 120e set out above. This additional tool comprises a server which communicates with the room hardware 104 via an IP address. A dial string, which comprises information obtained by the room hardware 104 from the integration system 100 is passed to the video call system 120e from the room hardware 104 via the server. An example dial string format is [IP Address]##[Meeting ID]#[Passcode]#[Command]#[Host Key]. The video call system 120e initiates the meeting using the room hardware 104 via the server.

It will be appreciated that the above method may use only a subset of integrated services in order to perform a modified function.

For example, the integration system 100 may be used to book a nearby bookable work area. In such an embodiment, the user may request, via the user device, to book a work area, and send location data along with the request. The booking management module 114c determines the location of the user device 102 on the floor plan and extracts relevant room booking statuses from the booking system 120c. The booking management module 114c provides suitable rooms to the user device, and books the room based on a user selection. That is, steps 5 to 12 of the method of FIG. 3 may by implemented independently of the other steps of the example method.

In another example, the scheduled event is an in-person meeting, that is there is no meeting data to be extracted from the video conference system 120e. Steps 2, 3, 13, and 14 of the method of FIG. 3 are removed in such an embodiment.

In some embodiments, the step of extracting the meeting data (steps 2 and 3) are implemented after the user has selected the room for booking, i.e. after step 11 or step 12 of the method of FIG. 3.

In some embodiments, the booking management module 114c selects the most suitable room and books the room without requiring approval from the user. That is, the booking management module 114c selects a most appropriate room at step 9 and proceeds to book to room, step 12. The user is then provided with information regarding the booking via the user interface.

The method set out above removes the requirement for a user to manually initiate a meeting, for example by entering a meeting ID and/or meeting password. All meeting data required to initiate the meeting is passed to the room hardware 104 such that the meeting is initiated remotely and automatically, without requiring any input from the user to start the meeting.

In some embodiment, the room hardware 104 comprises environment controllers. In such an embodiment, the method of FIG. 3 may be modified to actuate the environment controllers when, or slightly before, a room booking or meeting commences. In such an embodiment, a further service system 120, a building management system, may be integrated with the integration system 100. The building management system may define building conditions, such as a set temperature based on a number of people occupying a space, lighting requirements for different events/environment, etc.

Booking and Scheduling with Collaborators

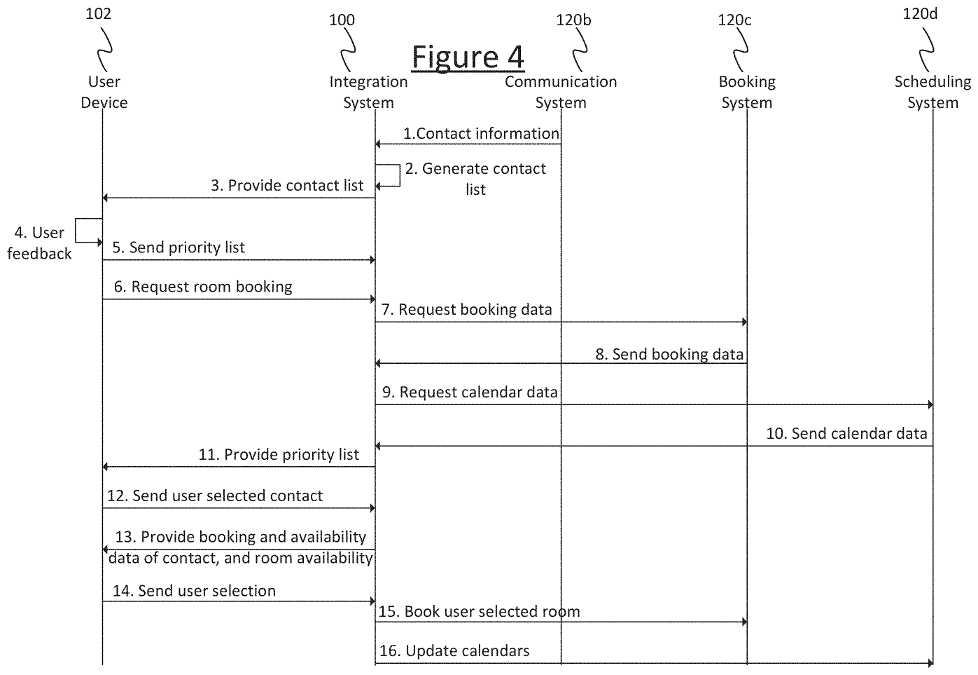

FIG. 4 shows an example use case in which a contact list associated with the user is used to book a work area. The integration system uses data extracted from the booking system 120c, scheduling system 120d, and communication system 120b in the example of FIG. 4.

Contact information is retrieved by the contact management module 114b via the contact API 110b from the communication system 120b. The contact information comprises an identifier of the contact, contact details such as an email address, and may further comprise one or more of contact frequency data, contact group data, and contact location data.

Contact frequency data refers to data relating to the frequency of communication between the user and the contact. For example, how frequently the user and contact exchange emails and/or instant messages (IMs). Contact group data refers to one or more indicators of predefined groups. For example, a company may define a set of groups, such as work teams or departments, and assign each employee to one or more of the groups. The contact information of each employee comprises an identifier of each group they have been assigned to. Contact location data refers to an identifier of a main office location the contact attends. For example, a company may have an office in London and an office in Edinburgh, with each employee being associated with one of the two offices at which they predominantly work. The contact information of each employee comprises an identifier of the office to which the employee is assigned.

The contact management module 114b generates a contact list based on a set of rules stored in the contact management database 130b. These rules can be defined, altered, and deleted at a back-end server. The contact list comprises contacts which may be useful for the user to have information about when booking a work space. For example, the contact list may comprise the user's contacts with whom the user frequently interacts and who are based in the same office as the user.

The contact list is an ordered list, with a most relevant contact having a higher place in the order. How contacts are prioritised are defined by the set of rules, for example by applying weights to contact features. For example, location may be assigned a higher weight than interaction frequency. Therefore, a contact who is in the same location as the user but is in contact with the user only intermittently would be prioritised above a contact who is in frequent contact with the user but in a different location.

It will be appreciated that other contact features may be used to generate the ordered list of contacts.

The contact list is then provided to the user device 102 and displayed to the user in a contact list editing interface. Via this interface, the user is able to reorder the list of contacts and add and/or remove contacts from the list. The user amended list is referred to as a priority list.

The priority list is sent from the user device 102 to the contact management module 114b.

The user may be satisfied with the ordered list provided by the contact management module 114b and therefore decide not to amend the list. In this case, the user provides an input indicating that the provided list is suitable, resulting in the provided ordered list being the priority list. In this case, either the contact list is sent back to the contact management module 114b or a command to use the contact list is sent and processed by the contact management module 114b.

The priority list is stored in the contact management database 130b in association with the user identifier.

The user, via the user device 102, requests to make a work area booking. The request is sent to the booking management module 114c, which requests from the contact management module 114b the priority list of contacts associated with the user. Using the priority list, the booking management module 114c extracts, via the booking API 110c, the booking data associated with the contacts identified on the priority list from the booking system 120c. The booking data may be extracted for a predefined time period. For example, the booking data of the contacts for the next 14 days may be extracted. The booking data of the user may also be extracted by the booking management module 114c.

The booking management module 114c also sends a request to the schedule management module 114d for the schedule data of each of the contacts on the priority list. The schedule management module 114d extracts, via the schedule API 110d, the schedules of each of the contacts on the priority list. The schedules may be extracted for a predefined time period. For example, the schedules of the contacts for the next 14 days may be extracted. The schedule of the user is also extracted by the schedule management module 114d. The schedule of the user extracted corresponds to at least some of the same time period as those extracted for the contacts.

The rendering component 116 renders a user interface based on the information extracted by the integration system 100. The user interface is provided to the user device 102. The user interface comprises the priority list.

The user selects, via the user interface, one of the contacts from the priority list. The user selected contact is provided to the booking management module 114c and the scheduling management module 114d.

The booking management module 114c and the scheduling management module 114d provide booking information and scheduling information regarding the selected contact to the rending component 116 for rendering a contact user interface, which is provided to the user device 102. The booking management module 114c also provides at least one available work area near the work area booked by the user select contact.

Using the provided information, the user can book a work area for themselves, schedule a meeting with the selected contact, and book a work area for the meeting.

In order to book a work area, whether for the user alone or for a meeting, the user selects an available work area. The user device 102 sends the user selected area with a booking request to the booking management module 114c. The booking management module 114c uses the received user selection to change the status of the work area at the booking system 120c, via the booking API 110c. The booking request may include a time for the work area to be booked.

To schedule a meeting, the user selects a time at which the selected contact is available, and sends the selected time in a scheduling request to the schedule management module 114d. The scheduling request comprises the time of the event, identifiers of the required participants, and the location of the meeting (if applicable). The scheduling request may further comprise user readable meeting information, such as a meeting title and meeting agenda.

The scheduling management module 114d may provide one or more suggested meeting times at which the user and the selected contact are both available, based on the user's and the contact's schedules. The user selected meeting time is one of the suggested meeting times.

The schedule management module 114d schedules the meeting in the calendars of the user and the selected contact stored at the scheduling system 120d via the scheduling API 110d.

It will be appreciated that steps 1 to 5 of the method of FIG. 4, that is, the steps for setting up the priority list of contacts, are not required to be implemented every time the user wishes to book a room and/or meeting with a contact. Steps 1 to 5 may be executed at predefined intervals, for example once a week. Alternatively or additionally, steps 1 to 5 may be implemented at the request of the user, that is in response to a priority list generation request received from the user device 102.

In some embodiments, the steps of extracting booking data (steps 7 and 8) and extracting the calendar data (steps 9 and 10) may be implemented only if the user requests both sets of data. For example, if the user does not need to have a meeting with a contact, that is the user wishes to book a desk near the contact but does not need to know the availability of the contact, the request to make a booking may comprise only a request for booking data. As such, the booking management module 114c extracts the booking statuses of the relevant areas from the booking system 120c for providing to the user.

In some embodiments, steps 9 and 10 may be implemented after step 12, that is after the user has selected the contact. In such an embodiment, the calendar data of the user and the selected contact is extracted from the scheduling system 120d, but not the other contacts on the priority list.

In another example, the user wishes to set up a meeting with the contact, however the meeting need not be in person. At step 6 of the method of FIG. 4, the user device instead provides a meeting request to the scheduling management module 114d, which extracts the calendar data of the contacts for providing to the user.

In some embodiments, the booking information extracted at step S of the method of FIG. 4 may be used to generate push notifications. For example, the booking management module 114c determines, based on the extracted schedules of the priority contacts and the user, one or more days on which the user is not booked to be in the office, but at least one of the priority contacts is. The booking management module 114c determines a near by available desk and provides a push notification to the user device 102 which indicates which contact is going to be in the office on which date, and the available work area. The user can book, via a user input of the notification, the suggested work area for the suggested day. This command is used by the booking management module 114c to book the work area for that day for the user in the booking system 120c.

In some embodiments, the booking management module 114c comprises a machine learning module. The machine learning module learns user work area booking preferences based on historic bookings. For example, the machine learning module may learn, from the historic bookings, that the user prefers to sit near a window and have a desk with dual screens. The machine learning module updates a set of rules for determining a suitable work area to suggest to the user based on the learnt preferences.

In some embodiments, the user is able to define multiple different priority lists. When booking a work area, the user may select which of the priority lists to use.

It will be appreciated that the method of FIG. 4 is not limited to priority lists generated based on frequency of interactions. The user may select, for example, a contact from a team contact list defined by the company based on the official roles of the contacts. In some embodiments, the contacts from which the user can select to book a nearby work area comprise all contacts in the company, that is the list is not tailored for the user. These contacts may still be referred to as contacts of the user since both the user and the contacts are associated with the company.

### Further Uses

The integration system 100 may be used for building access management. In such an embodiment, the integration system 100 integrates the booking system 120c and an access system (not shown). The access system controls equipment for allowing and preventing access to the building or parts of the building. For example, if a valid swipe card is used to unlock a door at the building entrance, the access system control which swipe card can open the door and at what times.

The booking management module 114c extracts booking data from the booking system 120c. The booking data is passed to an access management module (not shown) which processes the booking data to determine which users have booked a bookable work area for the upcoming working day.

Identifiers of these users are then provided to the access system. The access system modifies access requirements such that the identified users are able to unlock the building door with their swipe cards, but no other users are able to.

In a similar manner, the integration system 100 can be used to manage visitor access to the building. In this embodiment, data is extracted from a visitor system which defines the verified visitors. This data is used instead of the booking data in the example above to define the users who are allowed to access the building and thus the user identifiers to pass to the access system.

A health and safety system may also be integrated with the integration system 100. The health and safety system may be used to determine if a user is fit to enter the office. For example, the health and safety system may be used to generate a health check-list for users and provide user requirements for office use. The health and safety system can store results provided by the users and determine if a user meets the requirements for office entry, that is if they are healthy and have agreed to the conditions for office use.

The integration system 100 may access data stored at the health and safety system to determine if a user meets the requirements to entre the building. This data can be combined with the booking data to generate a list of users who are both booked into the office and who meet the health and safety requirements. This list is then provided to the access system for defining the users who are eligible to access the building.

### User Interface

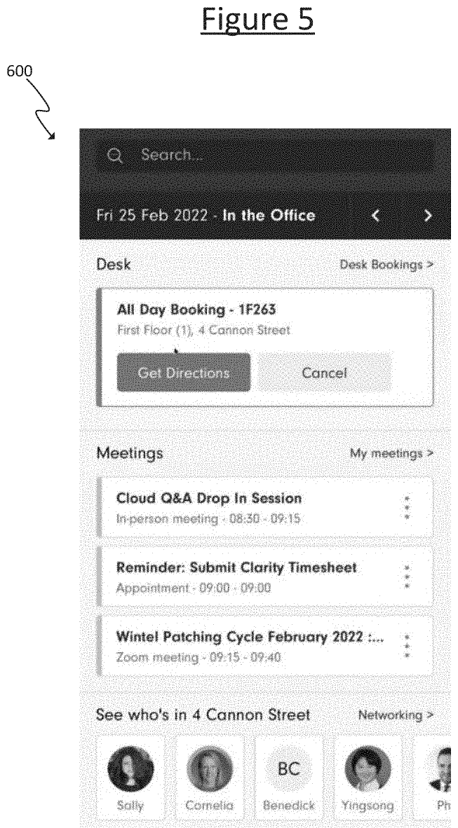

FIGS. 5 to 12 provide example user interfaces of the application for providing the functionalities described above to the user. The application may be stored locally in a memory of the user device 102 or it may be accessed via web browser for example. The user interfaces described below provide further use cases to those described above. It will be apricated that the modules 114 of the integration system 100 communicate with the service systems 120 via the APIs 110 as described above to implement each of the uses set out below.

FIG. 5 shows an example user dashboard 600. The user dashboard 600 provides user specific information to the user, such as desk bookings, scheduled meetings, and nearby contacts.

The dashboard 600 of FIG. 5 shows the user specific data associated with Friday 25 Feb. 2022. The user has booked a desk with desk identifier 1F263, has three meetings scheduled, and has at least 5 contacts who have also booked a desk in the same building on that day.

The user dashboard 600 may be provided to the user when they open the application and may be used as a homepage via which the user navigates the functionalities of the application. The user may also navigate the application by way of a sidebar or dropdown menu (not shown) or a search function.

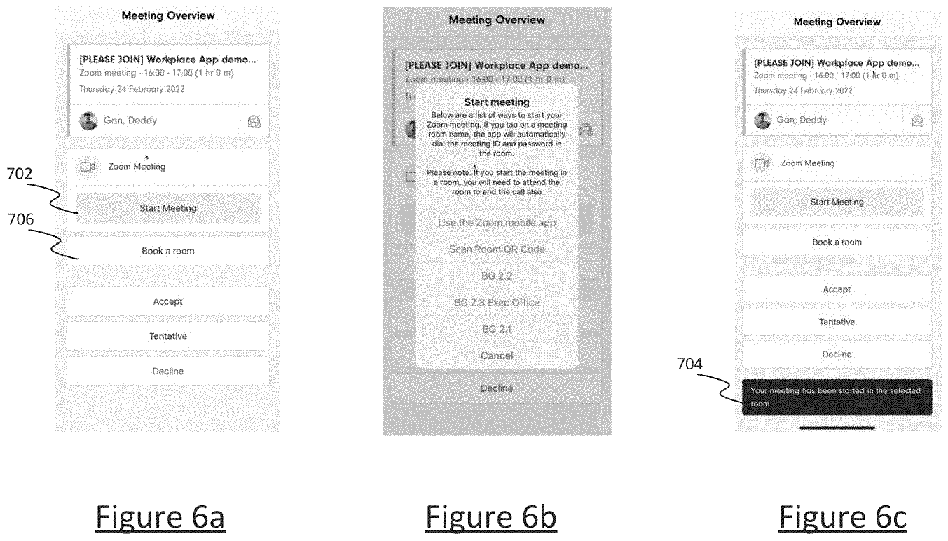

FIGS. 6a-c provide an example user interface for starting a scheduled meeting. The user selects, from the dashboard 600 or a “My Meetings” page providing all of the user's scheduled meetings, a scheduled meeting. The user's scheduled meetings are extracted from the scheduling system 120d by the schedule management module 114d.

A meeting overview page, as shown in FIG. 6a, is provided to the user. The meeting overview page provides the type of meeting, that is the video conferencing system 120e hosting the meeting, and other meeting details such as the subject, time, duration, remaining time, organiser and/or participants, extracted from the scheduling system 120d and/or the video conferencing system 120e.

The meeting overview page comprises a “Start Meeting” user selectable element 702. When the user selects the element 702, the meeting details required to launch the meeting are extracted from the video conferencing system 120e, such as the meeting ID and passcode, by the call management module 114e such that the meeting can be launched.

The user is provided with a set of meeting launch options, as shown in FIG. 6b. The meeting launch options include, in this example, the use of a mobile application of the video conferencing system 120e, scanning a QR code provided in a bookable area of the working environment to launch the meeting in said environment, and a selection of rooms close to the user device 102 which have suitable room hardware 104 for providing the meeting. The rooms provided are based on the physical location of the user device 102 as determined using the positioning system 106. Alternatively, the user's desk booking information may be used, extracted from the booking management system 120c.

The user selects one of the meeting launch options provided. If the user selects the use of the mobile application of the video conferencing system 120e, the meeting is launched in, or via, the mobile application of the video conferencing system 120e. For example, a Zoom application installed on the user device 102 may be launched with the meeting details preloaded. If the application is not installed on the user device 102, a webpage of the video conferencing system 120c may be launched.

If the user selects the scan QR code option, a camera of the user device 102 is accessed and used to capture the QR code provided in the desired room. The QR code is associated with the room hardware 104 of the room. By scanning the QR code, the meeting details are passed to the room hardware 104 to launch the meeting on that room hardware 104.

If the user selects one of the room suggestion options, the meeting details are passed to the room hardware 104 of the associated room to launch the meeting on that room hardware 104.

In the example provided in FIGS. 6a-c, the user selects one of the room suggestion options. The user is then presented with a confirmation notification 704 which indicates that the meeting has been started in the selected room, as shown in FIG. 6c.

The example of FIGS. 6a-c correspond to the example method shown in FIG. 3. That is, the user's location is used to determine suitable bookable locations using the booking system 120c.

The user may start the meeting at or after the scheduled start time of the meeting. In some embodiments, the user may start the meeting before the start time. There may be a predefined start period defining a period of time preceding the meeting in which the user can start the meeting, for example 5 minutes before the start time.

Any meeting participant may be able to start the meeting. In some embodiments, only a subset of participants, such as the meeting organiser or other assigned meeting admin participants, can select a room in which to initiate a meeting.

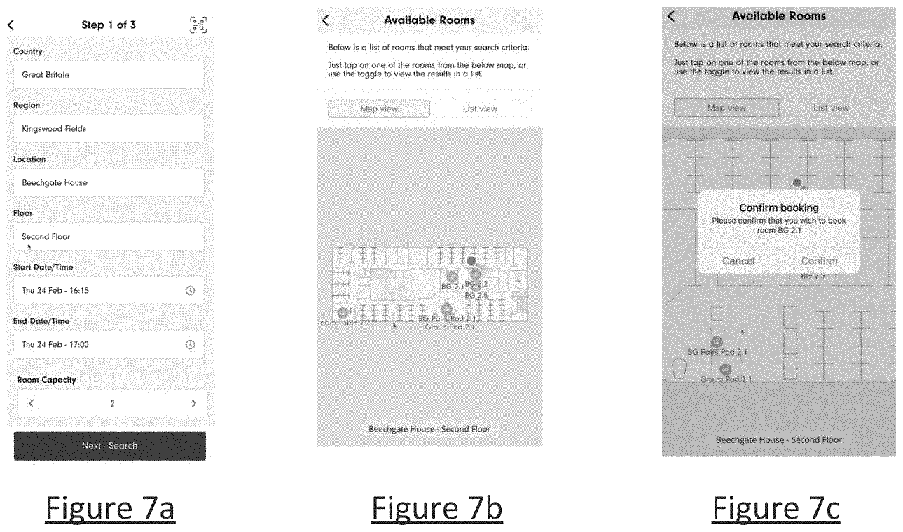

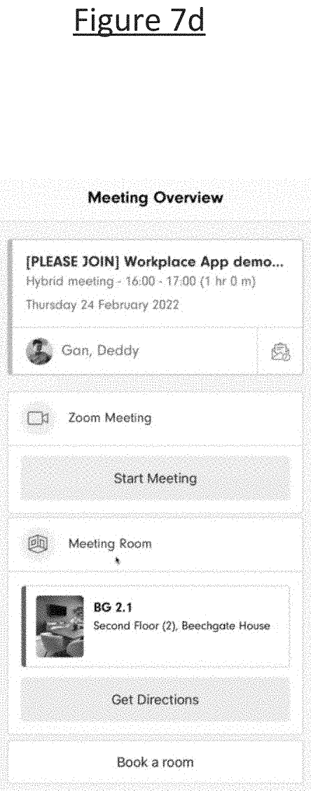

FIGS. 7a-d show an example user interface for booking a room for a meeting. This functionality may be used to book a room prior to the start of the meeting or once the meeting has started.

The user selects a “Book a Room” user selectable element 706 on the meeting overview page (see FIG. 6a). A booking form, shown in FIG. 7a, is then provided to the user, pre-populated with the date and time of the scheduled meeting. This data is extracted from the meeting data extracted from the scheduling system 120d or the video conferencing system 120e.

The form may also be pre-populated with a location, which in the example of FIG. 7a includes a country, region, building (shown as “location”), and floor. This information may be derived from the physical location of the user device 102, determined using the positioning system 106, or the user's desk booking information for the day in question, extracted from the desk booking system 120c.

The user can alter the location information in the form, as well as the time and date information.

The form also comprises a room capacity field, via which the user can define a minimum room capacity that the room must have. Other room attribute fields may also be provided, such that the user can define other requirements of the room prior to booking.

Once the user is satisfied with the booking requirements entered in the booking form, the information is used by the booking management module 114c to determine suitable rooms. The desk booking system 120c is accessed to determine the rooms which are available at the required time. The room specification of each available room is accessed from the database 130c of the booking management module 114c to determine which available rooms meet the requirements defined in the booking form.

The user is presented with a visual floorplan, as shown in FIG. 7b, showing the available rooms which meet the meeting requirements. In the example shown in FIG. 7b, each of the suitable available rooms are shown with a green icon. The user may, alternatively or additionally, be presented with the available suitable rooms in a list format.

The user selects a room they wish to book by tapping or clicking on the icon associated with the room. The user is then presented with a confirmation request, shown in FIG. 7c, which the user uses to confirm the room booking. When the user confirms the booking, the booking request is sent to the desk booking system 120c.

The meeting overview page is updated to show the now booked room, shown in FIG. 7d. The user is provided with an option for obtaining directions from the user's current location, determined by the positioning system 106, to the booked meeting room.

The room booking information may also be sent to the scheduling system 120d for updating the scheduled event data. The room booking information is sent with an identifier of the scheduled meeting so that the event can be updated in the schedules of each participant of the meeting.

In the example shown in FIG. 7a, the start time of the meeting used to populate the booking form is after the scheduled start time of the meeting. This may be the case if the scheduled start time has already passed, for example if the user attempts to book a room for the meeting after the meeting has started. The pre-populated time may be provided in, for example, five-minute increments, with the start time provided in the form being the start of the next increment. The availability search is therefore performed for the remaining scheduled time of the meeting.

It will be appreciated that, although booking a room and initiating a call in a room are shown to be instigated via different user interfaces as shown in FIGS. 7 and 7 respectively, by initiating a call in a room, using the interface of FIG. 6, the room may also be booked, or vice versa. That is, when the user selects the room in the user interface provide in FIG. 6b, the meeting data is passed to the room hardware 104 and a booking request is sent to the booking system 120c. In such an embodiment, the booking system 120c is accessed prior to providing the suggested rooms to the user such that the user is only presented with rooms which are vacant at the time of the meeting. Alternatively, by booking a room for the meeting using the interface of FIG. 7, the meeting data may be extracted from the video conferencing system 120e and transmitted to the room hardware 104 of the booked room at the start time of the meeting.

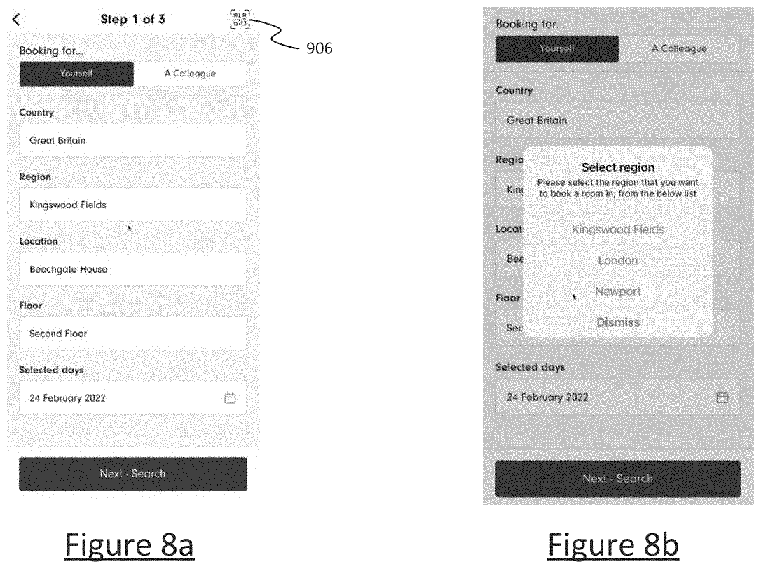

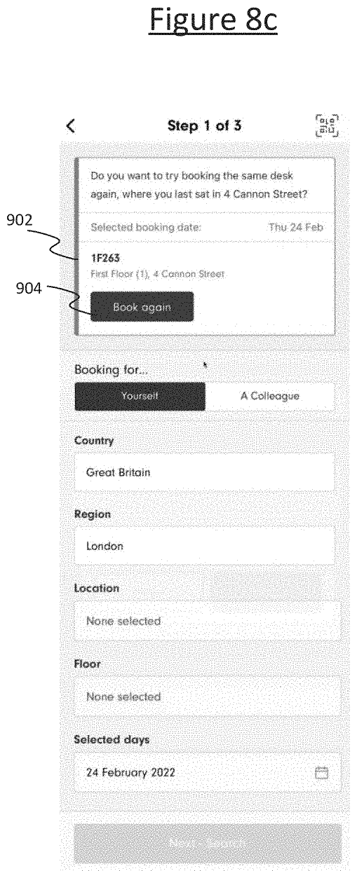

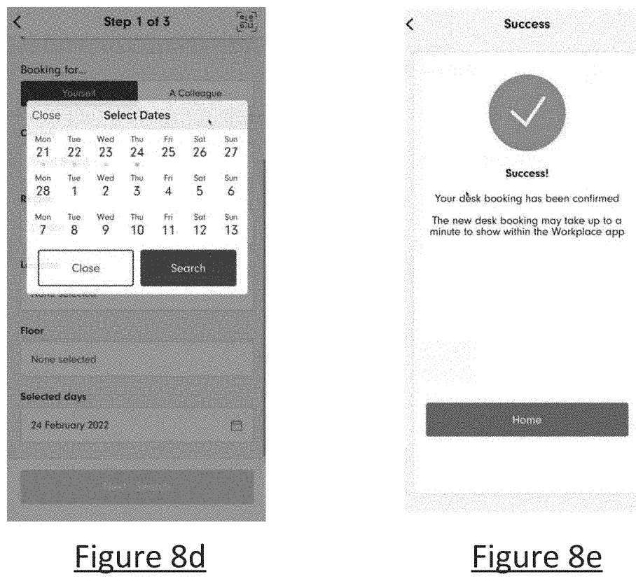

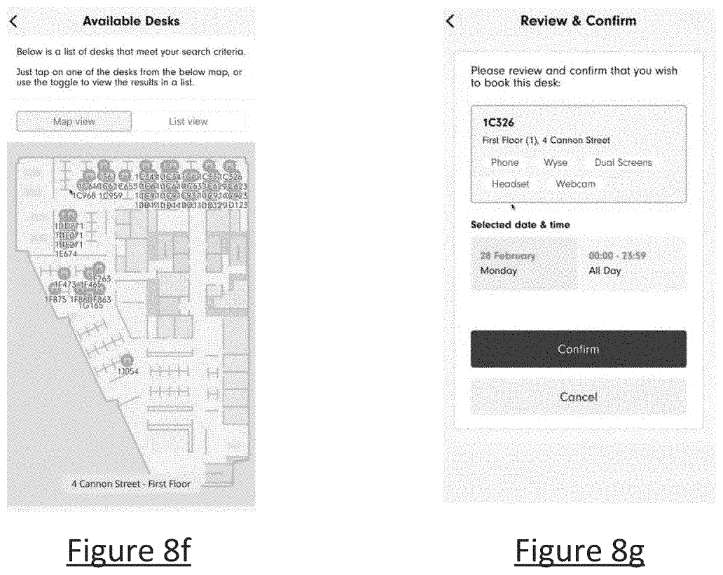

FIG. 8a-g show an example user interface for booking a desk, or other bookable area, in a work environment.

The user starts a booking request for example via the dashboard 600. A booking request form, as shown in FIG. 8a, is provided to the user.

The booking request form is initially presented to the user in a pre-populated state. The fields of the form are pre-populated based on the user's current location. This is determined using the positioning system 106 and/or based on GPS data of the user device 102. Alternatively, the pre-populated information may be based on the user's “home” office, that is the office or location to which the user is assigned. The pre-populated date may be the present date or the date of the next working day.

If the user intends to book a desk at the location corresponding to the pre-populating information, the user selects the search icon in order to see the available desks. This is discussed below with reference to FIG. 8f.

If, however, the user intends to book a desk at a different location, the user can edit the information in the booking form. For example, the user selects the region field of the booking form and is presented with a list of the possible regions, as shown in FIG. 8b. The user selects the desired region from the presented list. The step can be repeated for other location fields of the form.

Based on the user's booking history, extracted from the desk booking system 120c, a desk suggestion 902 is provided to the user, as shown in FIG. 8c. The desk booking suggestion 902 may be the last desk the user booked in the selected location, or may be a desk the user has repeatedly booked in the selected location.

In some embodiments, the desk provided in the desk suggestion 902 is provided to the user if available on the selected date. In the event that the previously booked desk is not available, the desk suggestion 902 indicates a desk close to the previously booked desk. In some embodiments, the desk suggestion 902 may indicate that the suggested desk is different to the previously booked desk. In other embodiments, the desk suggestion may not be provided to the user if the previously booked desk is not free.

The user may alter the date they wish to book the date for by selecting the date field. A calendar is presented to the user, shown in FIG. 8d, and the user selects one or more dates they wish to book a desk for by selecting dates on the calendar. The selected dates are used to populate the booking form.

If the user would like to book the desk provided in the booking suggestion 902, the user selects the “Book Again” element 904. In response, a booking request is sent to the desk booking system 120c, which generates a booking as defined in the request for the user. The user is presented with a confirmation message, shown in FIG. 8e, to confirm that the booking as been successful. The booking subsequently appears in a desk bookings section of the dashboard 600 and a “Desk Bookings” page of the user's application which provides all of the user's desk bookings.

If the user does not wish to sit at the suggested desk, the user populates the form, or uses the pre-populated form, to search for a desk in the requested area. The user selects the search button on the booking form.

A visual floorplan is presented to the user, as shown in FIG. 8f, indicating each room which satisfied the user's request. The desk booking system 120c is accessed to determine available desks, and the databased 130c of the booking module 114c accessed to check the specifications of the available desks. The suitable desks may also or alternatively be provided in a list format.

The user selects a desk from the available desks provided on the floorplan. A review page is provided to the user, as shown in FIG. 8g. The review page indicates the location of the desk, the date and time of the booking request, and may further indicate the attributes, such as the provided hardware, associated with the desk. The user selects the “confirm” element to cause the booking request to be sent to the desk booking system 120c. The confirmation message, as shown in FIG. 8e, is presented to confirm the booking.

The user may also be able to book a desk by scanning a QR code associated with the desk. The user selects a scan element 906 (see FIG. 8a) of the booking form. This allows the application access to the camera of the user device 102 such that the QR code can be captured. Once captured, a booking request is generated using the data from the QR code and sent to the desk booking system 120c. If available, a booking is generated at the desk booking system 120c for the user.

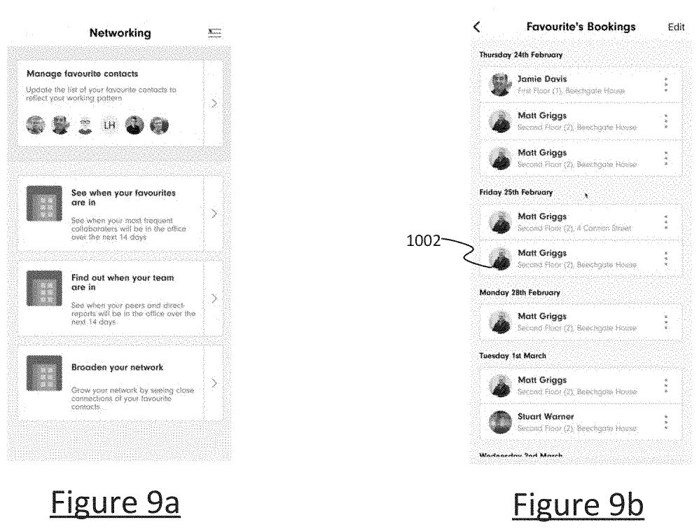

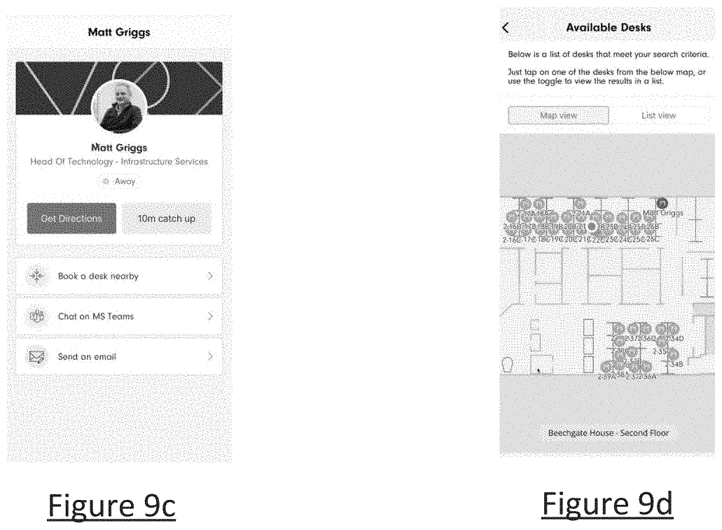

FIGS. 9a-d show an example user interface for booking a desk near a contact.

FIG. 9a shows an example networking page. The networking page includes options for booking near “favourite contacts” and “team” contacts, both of which may be referred to as “preferred contacts” herein. “Team” contacts are defined by a structure of the company, and therefore cannot be edited by the user. The “favourite contacts” can be edited by the user, for example by selecting the “manage favourite contacts” element of the networking page. The favourite contacts may be based on the user's frequent contacts as discussed above, and may be further edited by the user to add or remove contacts.

To book a desk near one of the user's preferred contacts, either a “team” contact or a “favourite” contact, the user selects the selects the element of the networking page for seeing bookings of their contacts. In the example of FIGS. 9a-d, the user wants to find a desk near a favourite contact, so selects the “see when your favourites are in” element of the networking page.

The user is presented with a “Favourite's Bookings” page, shown in FIG. 9b. This page shows all of the upcoming bookings of the user's favourite contracts, extracted from the desk booking system 120c.

The Favourite's Bookings page shows each of the user's favourite contacts who have booked a desk on each day, and the location at which they have booked. The user can use this list to decide when and where to book a desk.

To book a desk near a preferred contact on the same day as the contact's booking, the user selects the contact's booking 1002. The user is presented with a contact information page, as shown in FIG. 9c. The contact information page provides information about the contact, such as job title, department, and availability status. The contact information page also provides links for interacting with the contact. In the example of FIG. 9c, these links include a “Get Directions” element, a “10 m catch up” element, a “book a desk nearby” element, a “Chat on MS Teams” element, and a “Send an email” element.

If the user selects the “Get Directions” element, the physical location of the user device 102, determined using the positioning system 106, is used to direct the user to the desk currently booked by the contact.

If the user selects the “book a desk nearby” element, the desk booking system 120c is accessed to find the available desks near that of the contact on the date correspond to the contact booking 1002 selected by the user. For example, if the user selected the contact booking 1002 for Friday 25 February, the desk availability for Friday 25 February is accessed from the desk booking system 120c, as well as the booking associated with the contact. The floorplan stored in memory 130c of the booking module 114c may be used to determine nearby desks to that booked by the contact.

A floorplan, indicating available desks and the desk booked by the contact, is presented to the user, as shown in FIG. 9d. The user selects the desk they wish to book by selecting the icon associated with the desk. This causes a booking request to be transmitted to the desk booking system 120c. The user may be presented with a review page, as shown in FIG. 8g, before the request is sent as set out above.

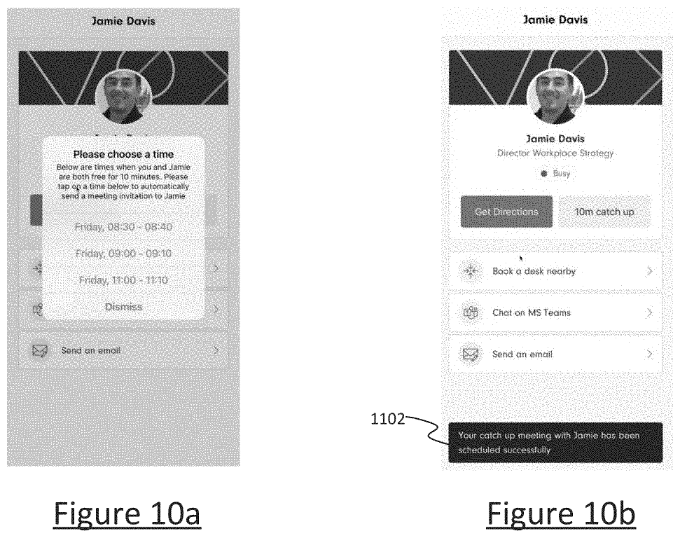

Referring to FIG. 9c, if the user selects the “10 m catch up” element, the user is presented with a list of possible 10-minute time slots during which both the user and the contact are free, as shown in FIG. 10a. The time slots are determined by accessing the schedules of the user and the contact from the scheduling system 120d and finding a 10-minute time slot both parties are available. The working hours of the user and the contact are considered when determining the time slots so that both parties are working during the proposed time slots.

The user selects one of the proposed time slots. A video call request is sent to the video conferencing system 120e to request a video conference call link for the selected time slot. The meeting data is retrieved and included in a scheduling request, transmitted to the scheduling system 120d for scheduling the video call at the selected time in the calendars of both the user and the contact. The meeting data includes at least the meeting ID so that the meeting data required to initiate the meeting can be extracted from the video conferencing system 120e when the meeting is started.

It will be appreciated that the time slot may be of another length of time.

Once the meeting has been added to the schedules of both the user and the contact, a confirmation notification 1102 is presented to the user, shown in FIG. 10b.

Referring to FIG. 9c, if the user selects the “Chat on MS Teams” or “Send an email” element, the communication system 120b is accessed to initiate an instant message or email respectively from the user to the contact.

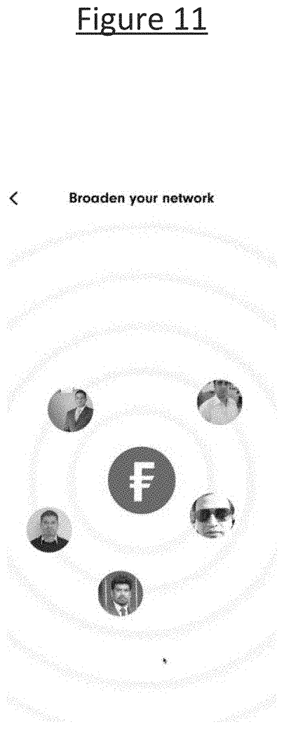

Another feature of the Networking page shown in FIG. 9a is the “Broaden your network” element. By selecting this element, the user is presented with five people with whom they are closely connected, but who do not appear on any of their contact lists. FIG. 11 shows an example interface for providing these “close contacts” to the user,

Close contacts may be people who are on the contact list of a contact of the user, or a person with whom a contact of the user frequently interacts. The communication system 120b may be accessed to determine the close contacts. The close contacts presented to the user are randomly selected from the eligible people. In the example of FIG. 11, five people are presented to the users, however any number of close contacts may be defined to be selected and provided.

An image associated with each close contact is presented to the user. If the user selects one of the images, the contact information page, as shown in FIG. 9c, is presented to the user.

It will be appreciated that the contact information page of a person/contact may be presented to the user in response to the user selecting any identifier of the person/contact in the application. For example, the user may select an icon of a contact on the dashboard 600, which cause the contact information page of that contact to be presented.

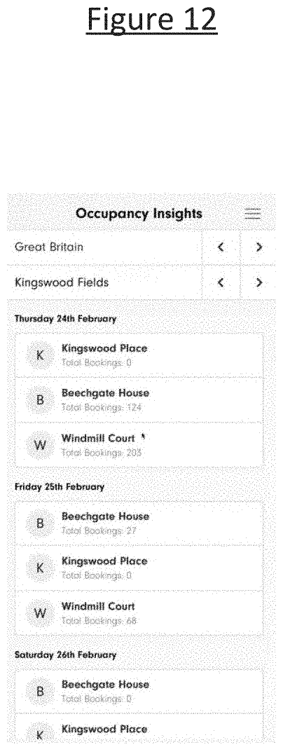

The integration system 100 may be used to provide further insights about the user's working environment and working day. For example, FIG. 12 shows an “Occupancy Insights” page, which provides the user with the occupancy of each building on any given day. In some embodiments, an indication of occupancy level may be visually represented on the occupancy insights page, such as a percentage occupancy of the building or a colour associated with the occupancy level. For example, two threshold occupancy levels may be defined, wherein the building is indicated in green if below the lower defined occupancy level, in orange if the occupancy level is between the two defined levels, and in red if above the higher occupancy level.

Occupancy insights may be provided at various levels of precision, such as building, floor, and area. The occupancy insights are based on the booking information of the desk booking system 120c.

Although not shown, a “book a desk” element may be provided associated with each location for each day on the occupancy insights page. In some embodiments, this option may only be provided if the occupancy level is below a preterminal threshold.

The integrated system 100 may provide further insights. For example, an alert may be sent to the user if a contact makes a desk booking on a day on which the user does not have a booking. The desk booking system 120c is accessed to determine a booked status of the user when the booking is made. The alert may comprise a “book a desk” element which the user can select to book a nearby desk. The user interface of FIGS. 8a-e or FIGS. 9c and d may be used to allow the user to book a desk.

As discussed above, the dashboard 600 may comprise a list of nearby contacts. The nearby contacts list comprises contacts of the user who are booked in the same office as the user on that day. The nearby list may further comprise other contacts who have booked desks in the same office. The user's contacts appear first in the list.

It will be appreciated that the user selectable information in the user interfaces described above may be provided to the user in other ways. For example, instead of providing user selectable dates, times and locations in pop-up messages, as shown in FIGS. 6b, 9b, 9d, and 11a, the user selectable items may be provided in a drop-down menu.

The video conferring system 120e may be referred to as a remote meeting system, and may refer to any system which allows two or more users at locations remote from each other to hold a meeting. This includes both video and audio meeting systems.

The examples described herein are to be understood as illustrative examples of embodiments of the instant disclosure. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the present disclosure, which is defined in the claims.

1. A computer system configured to effect integration of a booking system with a communication system, the booking system for managing bookable work areas within one or more workplaces, the communication system for effecting one or more communication modalities between users thereof, the computer system comprising:
a rendering component configured to render a user interface on a display of a user device operated by a user;
a contact management component configured to obtain, via a first interface of the communication system, a set of contacts of the user within the communication system; and
a booking management component configured to obtain a contact identifier from the set of contacts, locate, via a second interface of the booking system, an existing work area booking associated with the contact identifier, and generate a booking suggestion for the user comprising an identifier of an available work area, wherein the available work area is available at a suggested booking time, the available work area determined based on a timing and a location of the existing work area booking;
wherein the rendering component is configured to render the booking suggestion in the user interface, the booking suggestion selectable to cause a booking request to be submitted to the second interface, the booking request comprising an identifier of the user, the suggested booking time, and the identifier of the available work area.

2. The system of claim 1, wherein the system is further configured to integrate a scheduling system, the scheduling system for managing a schedule of each user thereof, wherein the system further comprises a scheduling management component configured to obtain, via a third interface of the scheduling system, a first portion of a first schedule associated with the user and a second portion of a second schedule associated with the contact identifier, wherein the first portion and the second portion comprise an overlap portion in time.

3. The system of claim 2, wherein the scheduling management module is further configured to determine, based on the first portion and the second portion, the suggested booking time.

4. The system of claim 2, wherein selecting the booking suggestion further causes a scheduling request to be submitted to the third interface, the scheduling request comprising the identifier of the user, the contact identifier, and the suggested booking time.

5. The system of claim 1, wherein the rendering component is configured to render at least one user selectable contact element in the user interface, each user selectable contact element corresponding to one of the set of contacts.

6. The system of claim 5, wherein the contact identifier is obtained based on a user selection of one of the at least one user selectable contact elements.

7. The system of claim 1, wherein the set of contacts is a set of preferred contacts, wherein the set of preferred contacts are generated based at least in part on relative frequency of communication between the user and the preferred contacts in the communication system.

8. The system of claim 1, wherein the set of contacts is a set of preferred contacts, wherein the set of preferred contacts is based at least in part on a user selection of contacts, wherein the contact management component is configured to maintain the set of preferred contacts.

9. The system of claim 1, wherein the booking management component is configured to receive the suggested booking time based on a user provided booking time.

10. The system of claim 1, wherein the booking management component is configured to determine the suggested booking time based on the existing work area booking.

11. The system of claim 2, wherein the scheduling management component is configured to determine the suggested booking time based on the first portion and second portion.

12. The system of claim 1, wherein the booking management component is configured to generate a plurality of booking suggestions, wherein the plurality of booking suggestions are rendered in the user interface.

13. The system of claim 1, wherein the booking suggestion is based on a set of defined work area requirements and a set of assigned work area attributes associated with the identifier of the available work area.

14. The system of claim 13, wherein the system is further configured to integrate a scheduling system, the scheduling system for managing a schedule of each user thereof, wherein the system further comprises a scheduling management component configured to obtain, via a third interface of the scheduling system, a first portion of a first schedule associated with the user and a second portion of a second schedule associated with the contact identifier, wherein the first portion and the second portion comprise an overlap portion in time, wherein the set of defined work area requirements are defined based on a scheduled event scheduled in the overlap portion.

15. A computer implemented method for effecting integration of a booking system with a communication system, the booking system for managing bookable work areas within one or more workplaces, the communication system for effecting one or more communication modalities between users thereof, the method comprising:
rendering, by a rendering component, a user interface on a display of a user device operated by a user;
obtaining, by a contact management component, via a first interface of the communication system, a set of contacts of the user within the communication system;
obtaining, by a booking management module, a contact identifier from the set of contacts, locating, via a second interface of the booking system, an existing work area booking associated with the contact identifier, and generating a booking suggestion for the user comprising and an identifier of an available work area, wherein the available work area is available at a suggested booking time, the available work area determined based on a timing and a location of the existing work area booking; and
rendering, by the rendering component, the booking suggestion in the user interface, the booking suggestion selectable to cause a booking request to be submitted to the second interface, the booking request comprising an identifier of the user, the suggested booking time, and the identifier of the available work area.

16. A computer program product comprising code stored on a computer readable storage medium and configured to implement a method for effecting integration of a booking system with a communication system, the booking system for managing bookable work areas within one or more workplaces, the communication system for effecting one or more communication modalities between users thereof, the method comprising:
rendering, by a rendering component, a user interface on a display of a user device operated by a user;
obtaining, by a contact management component, via a first interface of the communication system, a set of contacts of the user within the communication system;
obtaining, by a booking management module, a contact identifier from the set of contacts, locating, via a second interface of the booking system, an existing work area booking associated with the contact identifier, and generating a booking suggestion for the user comprising and an identifier of an available work area, wherein the available work area is available at a suggested booking time, the available work area determined based on a timing and a location of the existing work area booking; and
rendering, by the rendering component, the booking suggestion in the user interface, the booking suggestion selectable to cause a booking request to be submitted to the second interface, the booking request comprising an identifier of the user, the suggested booking time, and the identifier of the available work area.
